(19) United States
(12) Patent Application Publication
(10) Pub. No.: US 2023/0285248 A1
(43) Pub. Date: Sep. 14, 2023

(54) A FOLDABLE BABY BOTTLE

(71) Applicant: Linda ROZENBAUM, RISHON LEZIYYON (IL)

(72) Inventor: Linda ROZENBAUM, RISHON LEZIYYON (IL)

(21) Appl. No.: 18/020,987

(22) PCT Filed: Aug. 6, 2021
(86) PCT No.: PCT/IL2021/050960

§ 371 Date: Feb. 13, 2023

(30) Foreign Application Priority Data
Aug. 12, 2020 (IL) 276691

(51) Int. Cl. A61J 9/00; A61J 11/04

(52) U.S. Cl. CPC A61J 9/005; A61J 9/001; A61J 11/04

(57) ABSTRACT

In one aspect, the present invention is directed to a baby bottle, comprising: a foldable container; a bag; a flange welded to an opening of the bag; a nipple; a closure for securing the nipple to an opening of the container, such that the flange is disposed therebetween; wherein the bag is made of polyethylene and a thickness thereof is at least 0.04 mm, thus providing to the bag a stiffness which makes it difficult to fold the bag when being inserted into the container, while allowing folding thereof. Preferably, the flange is welded to the opening of the bag by ultrasonic welding.

### TECHNICAL FIELD

The present invention relates to the field of baby bottles.

### BACKGROUND ART

WO2015079434A1, to the same applicant, discloses a foldable infant bottle that uses one-time bags instead of a rigid container. One of the problems involved in using a bag instead of a rigid container is the fact that the bag has to be placed in the “bottle” such that its opening remains open wide. As a result, installation of a one-time bag in a baby bottle is cumbersome, and therefore is uncomfortable to the user, i.e., the parent.

GB2414006A discloses a collapsible fluids container which may be used as a disposable babies' bottle comprises a flexible bag or pouch 12 hermetically sealed to a cover 7 and provided with an opening for filling and means such as a non-return valve 8 to seal the container. The container is preferably supplied in a sterilized, flat packed, evacuated and/or folded hermetically packaged form. Alternatively, the container may be used in the preparation and/or consumption of fluids, disposal of fluids or the capture of samples.

As such, there is a felt need of a convenient and simple solution of installing a bag into a foldable baby bottle.

It is an object of the present invention to provide a solution to the above-mentioned and other problems of the prior art.

Other objects and advantages of the invention will become apparent as the description proceeds.

### SUMMARY OF THE INVENTION

In one aspect, the present invention is directed to a baby bottle (100), comprising:
a foldable container;
a bag;
a flange welded to an opening of said bag;
a nipple;
a closure for securing said nipple to an opening of said container, such that said flange is disposed therebetween;
wherein said bag is made of polyethylene and a thickness thereof is at least 0.04 mm,
thereby providing to said bag a stiffness which makes it difficult to fold said bag when being inserted into the container, while allowing folding thereof.

Preferably, the flange (11) is welded to the opening of the bag by ultrasonic welding.

Alternatively, the flange is welded to the opening of the bag by filament heating.

Yet alternatively, the flange is attached to the opening of the bag by tightening the bag between two rings.

According to one embodiment of the invention, the closure is a snap closure.

According to one embodiment of the invention, the closure is a threading closure.

According to one embodiment of the invention, the bottom of the bag is welded by ultrasonic welding.

According to one embodiment of the invention, the bottom of the bag is welded by filament heating.

The polyethylene may be of LDPE (Low Density polyethylene), HDPE (High Density polyethylene), and other.

The reference numbers have been used to point out elements in the embodiments described and illustrated herein, in order to facilitate the understanding of the invention. They are meant to be merely illustrative, and not limiting. Also, the foregoing embodiments of the invention have been described and illustrated in conjunction with systems and methods thereof, which are meant to be merely illustrative, and not limiting.

### BRIEF DESCRIPTION OF DRAWINGS

Preferred embodiments, features, aspects and advantages of the present invention are described herein in conjunction with the following drawings:

FIG. 1 is a longitudinal cross-section of a baby bottle in which is placed a bag, according to the prior art.

FIG. 2 schematically illustrates a baby bottle bag in different views, according to one embodiment of the invention.

FIG. 3 is a longitudinal cross-section of a baby bottle in which is placed a bag, according to one embodiment of the invention.

FIG. 4 is a longitudinal cross-section of a baby bottle ready for use, according to one embodiment of the invention.

It should be understood that the drawings are not necessarily drawn to scale.

### DESCRIPTION OF EMBODIMENTS

The present invention will be understood from the following detailed description of preferred embodiments (“best mode”), which are meant to be descriptive and not limiting. For the sake of brevity, some well-known features, methods, systems, procedures, components, circuits, and so on, are not described in detail.

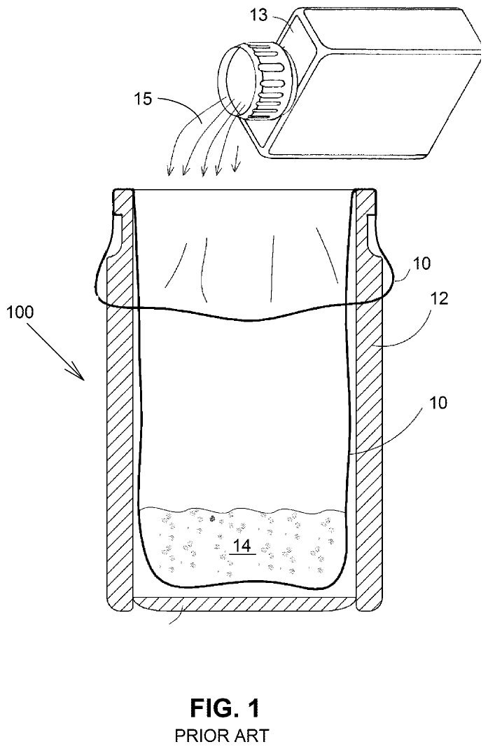

FIG. 1 is a longitudinal cross-section of a baby bottle (100) in which is placed a bag, according to the prior art.

The U.S. Federal Food, Drug, and Cosmetic Act (FFDCA) defines infant formula as “a food which purports to be or is represented for special dietary use solely as a food for infants by reason of its simulation of human milk or its suitability as a complete or partial substitute for human milk”.

In order to prepare baby food, the bag 10 has to be placed into a foldable container 12. Then, the infant formula 14 has to be poured into the bag 10. Then, water 15 has to be poured (e.g., from water bottle 13) into the bag 10, and mixed with the infant formula, e.g., by shaking the baby bottle 100.

As mentioned, placing the bag 10 into the foldable container 12 is a cumbersome operation since the bag folds, there is no indication if the bag fills the entire space of the bottle 100, etc.

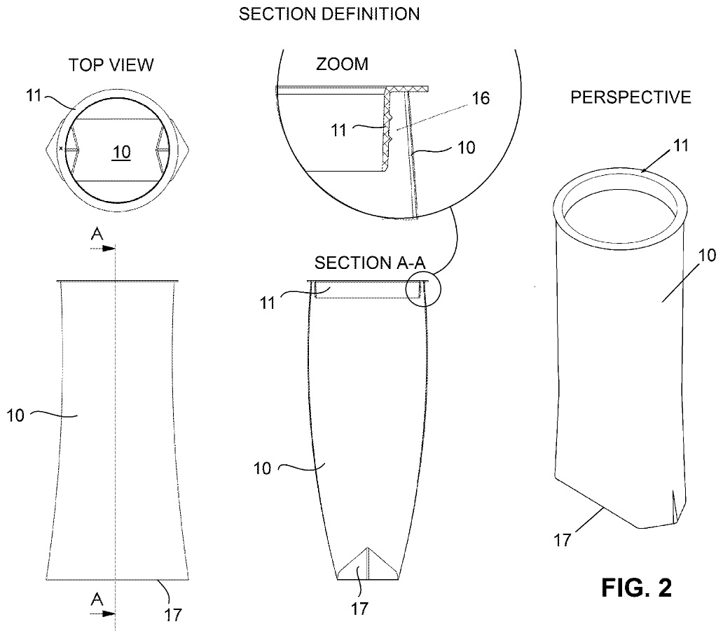

FIG. 2 schematically illustrates a baby bottle bag in different views, according to one embodiment of the invention.

The bottom 17 of the bag 10 is sealed. The sealing can be obtained by welding, such as ultrasonic welding, and heat welding.

To the rim of the opening of the bag is attached a flange 11. Assuming a flange comprises a cylinder to which is connected a ring then the bag is connected to the cylinder of the flange, and the ring prevents swallowing of the entire bag into the baby bottle.

The zoomed view is focused on the upper right corner of the cross section A-A of the bag. Reference numeral 16 denotes a region in which an ultrasonic welding attaches the flange to the bag rim.

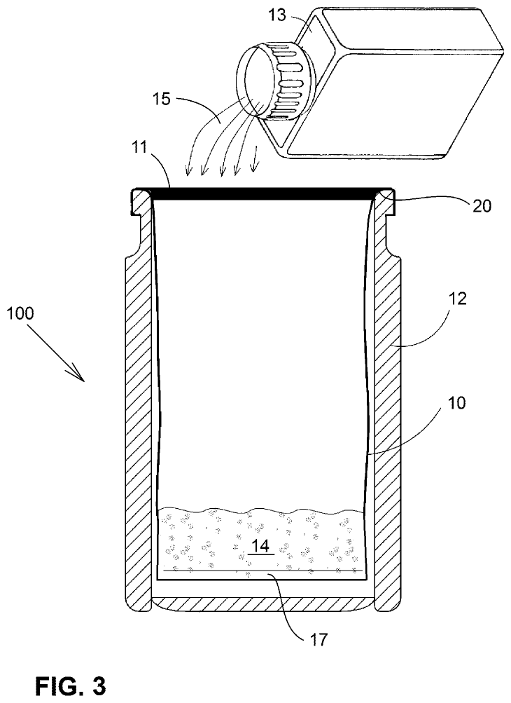

FIG. 3 is a longitudinal cross-section of a baby bottle in which is placed a bag, according to one embodiment of the invention.

Two elements distinguish the solution illustrated in this figure from the prior art solution illustrated in FIG. 1: (1) the use of a flange 11 as a part of bag 10, and (b) the substance the bag 10 is made of.

The material from which bag 10 is made is polyethylene. However, the material is adjusted to have certain stiffness so that the bag does not fold “easily”.

The flange 11 overlaps the rim of the foldable container opening so that the bag cannot be “swallowed” into the foldable container. Because of this, inserting a bag 10 into the foldable container 12 is a simple operation; much simpler in comparison to the prior art.

Preferably, the bag is made of PE (=polyethylene), whilst the flange is made of HDPE (=density polyethylene). In this case, the bag is foldable, which renders the bag compact, and therefore suitable for use in a foldable baby bottle as disclosed in WO2015079434A1.

Connecting a flange 11 to a bag 10 can be carried out in a variety of ways. The worst way is gluing, since glue can be toxic. Another way is heating by a filament, which actually welds the bag to the flange. Yet another way for attaching a bag to a flange is mechanical, such as tightening the bag between two rings. However, according to a preferred embodiment of the invention, connecting a flange 11 to a bag 10 is carried out by ultrasonic welding.

“Ultrasonic welding is an industrial technique whereby high-frequency ultrasonic acoustic vibrations are locally applied to workpieces being held together under pressure to create a solid-state weld. It is commonly used for plastics and metals, and especially for joining dissimilar materials. In ultrasonic welding, there are no connective bolts, nails, soldering materials, or adhesives necessary to bind the materials together.” (From Wikipedia)

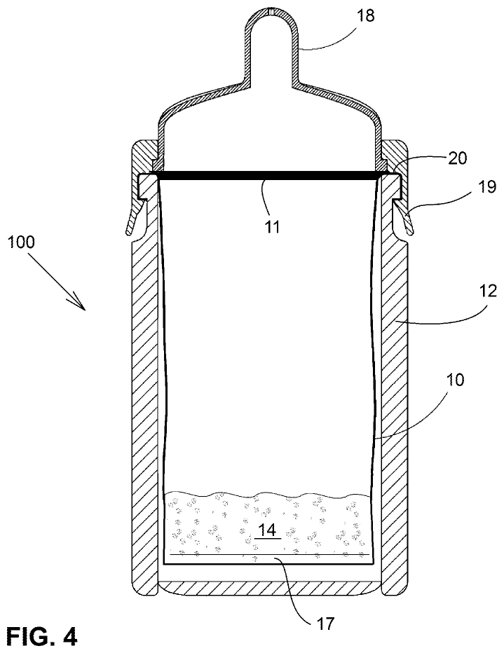

FIG. 4 is a longitudinal cross-section of a baby bottle ready for use, according to one embodiment of the invention.

As illustrated, closure 19 secures nipple 18 to the rim 20 of the foldable container 12 such that the flange 11 is disposed therebetween. In this way, the content of the bag can be poured out of the bag only via the nipple.

In order to provide to the bag a “light” stiffness, adequate to prevent from the bag to be folded upon insertion thereof into the foldable container, i.e., to provide “easy” insertion of the bag into the foldable container, the polyethylene the bag is made of has to be stiffer that a “regular” polyethylene bags.

Experiments made by the Applicant have shown that a thickness of 0.04 mm is adequate for providing the required stiffness.

Thus, the baby bottle comprising: a foldable container (12) a bag (10), a flange (11) welded to an opening of the bag, a nipple (18), a closure (19) for securing the nipple to the container such that the flange is disposed therebetween; wherein the thickness of the bag is at least 0.04 mm, thereby providing to the bag a stiffness adequate for preventing from the bag to “easily” fold when being inserted into the foldable container.

In the example of this figure, the closure 19 that secures the nipple to the container is a “snap-connector”; however, the securing may be carried out also by other securing means known in the art, such as threading.

Thus, the operations for preparing a baby bottle for use are:
inserting a bag into the baby container;
pouring infant formula into the bag;
adding water to the bag;
securing the nipple to the container such that the flange of the bag is disposed therebetween; and
mixing the content of the container (e.g., by shaking the bottle).

A major object of a foldable baby bottle is to obtain compactness, thereby allowing using the baby bottle outdoor. As the baby bottle bags are foldable, their storage is compact. Thus, the entire kit, i.e., foldable bottle and bags thereof, is compact.

As mentioned, in order to allow easy insertion of a bag into a baby bottle, the bag has to be of certain stiffness, such that on one hand provides to the bag foldability, but on the other hand provides a slight stiffness. Stiffness of a bag can be obtained by, for example, certain thickness of the bag substance, chemical structure, heat treatment, and other. The required stiffness can be determined by trial-and-error.

In the figures and/or description herein, the following reference numerals (Reference Signs List) have been mentioned:
numeral 100 denotes a foldable baby bottle;
numeral 10 denotes a baby bottle bag;
numeral 11 denotes a flange, attached to the rim of a baby bottle bag;
numeral 12 denotes a foldable container;
numeral 13 denotes a water bottle;
numeral 14 denotes an infant formula;
numeral 15 denotes a water;
numeral 16 denotes a region in which an ultrasonic welding attaches the flange to the bag rim;
numeral 17 denotes a bottom of bag 10;
numeral 18 denotes a baby bottle nipple;
numeral 19 denotes a closure; and
numeral 20 denotes a rim of foldable container 12.

In the description herein, the following references have been mentioned: WO2015079434A1, GB2414006A

The foregoing description and illustrations of the embodiments of the invention has been presented for the purposes of illustration. It is not intended to be exhaustive or to limit the invention to the above description in any form.

Any term that has been defined above and used in the claims, should to be interpreted according to this definition.

1. A baby bottle, comprising:
a foldable container;
a bag;
a flange welded to an opening of said bag;
a nipple;
a closure for securing said nipple to an opening of said container, such that said flange is disposed therebetween;
wherein said bag is made of polyethylene and a thickness thereof is at least 0.04 mm,
thereby providing to said bag a stiffness which makes it difficult to fold said bag when being inserted into said container, while allowing folding thereof.

2. A baby bottle according to claim 1, wherein said flange has been welded to said opening of said bag by ultrasonic welding.

3. A baby bottle according to claim 1, wherein said flange has been welded to said opening of said bag by filament heating.

4. A baby bottle according to claim 1, wherein said flange has been attached to said opening of said bag by tightening said bag between two rings.

5. A baby bottle according to claim 1, wherein said closure is a snap closure.

6. A baby bottle according to claim 1, wherein said closure is a threading closure.

7. A baby bottle according to claim 1, wherein a bottom of said bag is welded by ultrasonic welding.

8. A baby bottle according to claim 1, wherein a bottom of said bag is welded by filament heating.

9. A baby bottle according to claim 1, wherein said polyethylene is LDPE (Low Density polyethylene).

10. A baby bottle according to claim 1, wherein said polyethylene is HDPE (High Density polyethylene).
